(19) United States
(12) Patent Application Publication
(10) Pub. No.: US 2025/0378821 A1
(43) Pub. Date: Dec. 11, 2025

(54) SPEECH RECOGNITION MODEL TRAINING

(71) Applicants: Beijing Zitiao Network Technology Co., Ltd., Beijing (CN); Lemon Inc., Grand Cayman (KY)

(72) Inventors: Ming TU, Los Angeles, CA (US); Youjia HUANG, Beijing (CN); Chen SHEN, Beijing (CN); Lu LU, Los Angeles, CA (US); Yuxuan WANG, Los Angelese, CA (US)

(21) Appl. No.: 19/234,415

(22) Filed: Jun. 11, 2025

(30) Foreign Application Priority Data
Jun. 11, 2024 (CN) 202410749918.X

(51) Int. Cl. G10L 15/06; G10L 15/00; G10L 15/02

(52) U.S. Cl. CPC G10L 15/063; G10L 15/005; G10L 15/02

(57) ABSTRACT

A method, an apparatus, a device, and a storage medium for training a speech recognition model are described. An example method includes: obtaining first training data including a first set of speech data corresponding to a plurality of languages; training the speech recognition model by using the first training data to adjust a parameter of an encoding module; obtaining second training data, the second training data including a second set of speech data corresponding to the plurality of languages and first text data corresponding to the second set of speech data; processing the second set of speech data by using the speech recognition model to obtain second text data; and training the speech recognition model based at least on a comparison between the first text data and the second text data to adjust at least a parameter of the encoding module and a conversion module.

### CROSS-REFERENCE

The present application claims priority to Chinese Patent Application No. 202410749918.X, filed on Jun. 11, 2024, and entitled “METHOD, APPARATUS, DEVICE AND STORAGE MEDIUM FOR TRAINING SPEECH RECOGNITION MODEL”, which is incorporated herein by reference in its entirety.

### FIELD

Example embodiments of the present disclosure generally relate to the field of computer, and in particular, to speech recognition model training.

### BACKGROUND

With the development of Internet and computer technology, natural language processing has been developed. In the field of natural language processing, language models have been widely concerned and used. Therefore, the training of the language model becomes a focus problem concerned by people.

### SUMMARY

In a first aspect of the present disclosure, a method for training a speech recognition model is provided. The method includes: obtaining first training data including a first set of speech data corresponding to a plurality of languages; training a speech recognition model by using the first training data to adjust a parameter of an encoding module of the speech recognition model, the encoding module being configured to convert received speech data into a speech encoding representation; obtaining second training data, the second training data including a second set of speech data corresponding to the plurality of languages and first text data corresponding to the second set of speech data; processing the second set of speech data by using the speech recognition model to obtain second text data; and training the speech recognition model based at least on a comparison between the first text data and the second text data to adjust at least a parameter of the encoding module and a conversion module of the speech recognition model, the conversion module being configured to convert the speech encoding representation into a speech input feature matching a decoding module of the speech recognition model.

In a second aspect of the present disclosure, an apparatus for training a speech recognition model is provided. The apparatus includes: a first obtaining module configured to obtain first training data including a first set of speech data corresponding to a plurality of languages; a first training module configured to train a speech recognition model by using the first training data to adjust a parameter of an encoding module of the speech recognition model, the encoding module being configured to convert received speech data into a speech encoding representation; a second obtaining module configured to obtain second training data, the second training data including a second set of speech data corresponding to the plurality of languages and first text data corresponding to the second set of speech data; a third obtaining module configured to process the second set of speech data by using the speech recognition model to obtain second text data; and a second training module configured to train the speech recognition model based at least on a comparison between the first text data and the second text data to adjust at least a parameter of the encoding module and a conversion module of the speech recognition model, the conversion module being configured to convert the speech encoding representation into a speech input feature matching a decoding module of the speech recognition model.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium has a computer program stored thereon, and the computer program is executable by the processor to implement the method of the first aspect.

It should be understood that the content described in this summary is not intended to limit the key features or important features of embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIG. 2 shows a flowchart of a process of training a speech recognition model according to some embodiments of the present disclosure;

FIG. 3 illustrates a block diagram of an example for training a speech recognition model according to some embodiments of the present disclosure;

FIG. 4 shows a schematic structural block diagram of an example apparatus for training a speech recognition model according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including”, and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all the collection, obtainance, processing, management, forwarding and use of data are carried out on the premise that the user is aware of and confirms it. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, if personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function and does not affect the basic function of the user.

According to a conventional solution, a multi-language speech recognition system is mainly based on end-to-end a speech recognition solution, such as Connectionist Temporal Classification (CTC), Recurrent Neural Network Transducer (RNN-T), and the like. These models have problems such as utilization of context, lack of knowledge, and poor recognition effect on proper noun in a specific field. These problems may lead to inconsistent results of the model output, resulting in a dramatic decrease in the experience of a human-computer interaction based on speech.

Embodiments of the present disclosure provide a solution for training a speech recognition model. According to the solution, first training data including a first set of speech data corresponding to a plurality of languages can be obtained; the speech recognition model is trained by by using the first training data to adjust a parameter of the encoding module, the encoding module configured to convert received speech data into a speech encoding representation; second training data including a second set of speech data corresponding to the plurality of languages and first text data corresponding to the second set of speech data is obtained; the second set of speech data is processed by using the speech recognition model to obtain second text data; and the speech recognition model is trained based at least on a comparison between the first text data and the second text data to adjust at least a parameter of the encoding module and the conversion module, the conversion module configured to convert the speech encoding representation into a speech input feature matching the decoding module.

It may be understood that the data involved in the present disclosure, including but not limited to the data itself, the acquisition or use of the data, should follow the requirements of the corresponding laws and regulations and related regulations.

In this way, the embodiments of the present disclosure can train the speech recognition model by using the speech data corresponding to a plurality of languages to adjust a parameter of the encoding module and the conversion module in the speech recognition model, so that the speech recognition model can recognize speech content in the plurality of languages.

Various example implementations of this solution are described in detail below in conjunction with the accompanying drawings.

### Example Environment

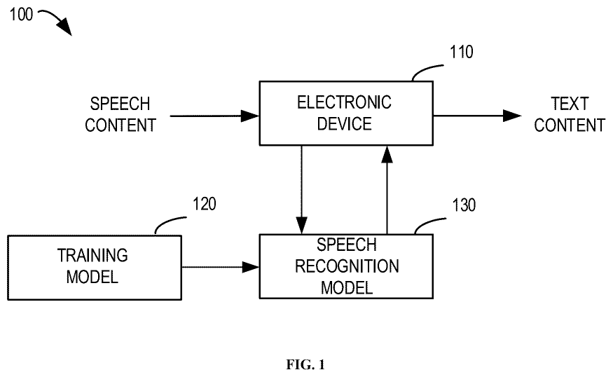

FIG. 1 illustrates a schematic diagram of an example environment 100 in which embodiments of the present disclosure can be implemented. As shown in FIG. 1, the example environment 100 may include an electronic device 110, a training device 120, and a speech recognition model 130.

In this example environment 100, the electronic device 110 completes a speech recognition task based on invoking the speech recognition model 130. The electronic device 110 is at least configured to output the received speech content as corresponding text content.

In some embodiments, the electronic device 110 may establish a communication connection with the speech recognition model 130. That is, the electronic device 110 may invoke a local or remote speech recognition model 130. So that input speech content is obtained from the electronic device 110, and the speech content is converted into corresponding text content. The speech recognition model 130 may be trained by a training device 120.

In some embodiments, the electronic device 110 and the training device 120 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 and the training device 120 can also support any type of interface for a user (such as a “wearable” circuit, etc.).

It should be understood that the structures and functions of the various elements in the environment 100 are described for illustrative purposes only and do not imply any limitation to the scope of the present disclosure.

### Example Processes

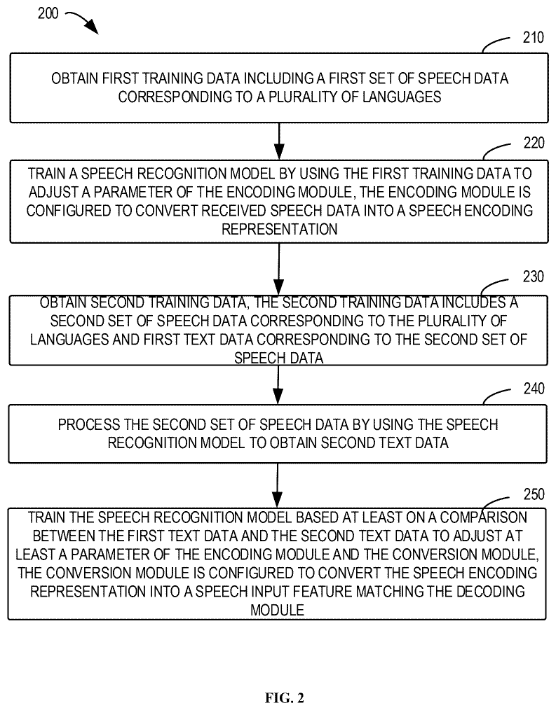

FIG. 2 shows a flowchart of an example process 200 for training a speech recognition model according to some embodiments of the present disclosure. The process 200 may be implemented at training device 120. The process 200 is described below with reference to FIG. 1.

In some embodiments, the training device 120 may train a speech recognition model 300, so that the electronic device 110 invokes the speech recognition model 300 to perform a speech recognition task of a multi-language type.

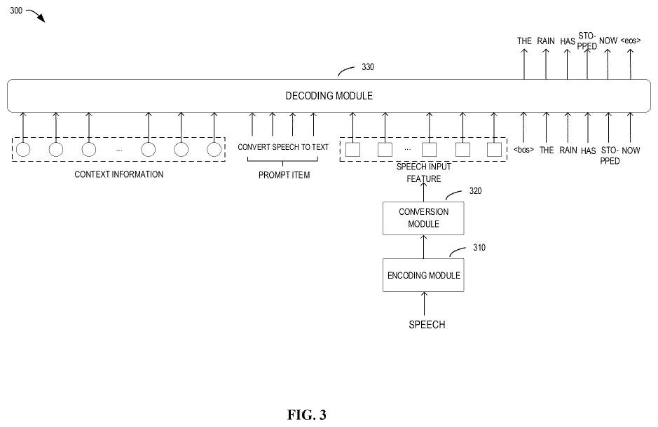

Referring to FIG. 3, the speech recognition model 300 includes an encoding module 310, a conversion module 320, and a decoding module 330. In some embodiments, the encoding module 310 is configured to encode the input speech into a speech feature, and convert the speech feature into a dimension (for example, a speech input feature) that can be processed by the decoding module 330 by using the conversion module 320. Further, the decoding module 330 generates text content corresponding to the speech based on the speech input feature, context information of the speech, and a prompt item related to the speech. In some embodiments, the decoding module 330 may be implemented, for example, based on a language model or other suitable machine learning model.

As shown in FIG. 2, in block 210, the training device 120 obtains first training data including a first set of speech data corresponding to a plurality of languages.

In some embodiments, the first set of speech data may be, for example, a set of unlabeled speech data corresponding to a plurality of languages. It may be understood that such the plurality of languages may include languages of different types, such as Chinese, English, Japanese, etc., and the present disclosure is not intended to limit the type of language.

At block 220, the training device 120 trains the speech recognition model 300 by using the first training data to adjust a parameter of the encoding module 310, and the encoding module 310 is configured to convert received speech data into a speech encoding representation.

In some embodiments, the training device 120 uses a set of unlabeled speech data to pre-train the encoding module 310 through a self-supervised learning (SSL) model, so that the encoding module 310 automatically converts the set of unlabeled speech data into a corresponding speech encoding representation. During the process of pre-training, the training device 120 may adjust the parameter of the encoding module 310 based on a loss function of the SSL.

At block 230, the training device 120 obtains second training data, the second training data including a second set of speech data corresponding to the plurality of languages and first text data corresponding to the second set of speech data.

In some embodiments, the training data includes a second set of speech data corresponding to a plurality of language types and corresponding first text data, and the first text data is a text form of the second speech data.

In some embodiments, after the training device 120 adjusts the parameter of the first stage on the encoding module 310, the training device 120 obtains the second training data (for example, a speech text pair), to perform training of a perspective module in the speech recognition model for the next stage.

At block 240, the training device 120 processes the second set of speech data by using the speech recognition model 300 to obtain second text data.

In some embodiments, the first text data may be used as annotation information of the second set of speech data. The training device 120 continues to train the speech recognition model 300 based on the comparison result (for example, the first loss value) between the annotation information and the second text data output by the speech recognition model 300.

In some embodiments, the training device 120 processes the target speech data in the second set of speech data by using the encoding module 310 in the speech recognition model 300 to generate a target speech encoding representation corresponding to the target speech data.

Further, the training device 120 converts the obtained target speech encoding representation into the target speech input feature by using the conversion module 320. In this manner, the target speech encoding representation is converted into a dimension that the decoding module 330 may process.

In some embodiments, the conversion module 320 may be designed based on simple linear mapping or a more complex converter network. The present disclosure is not intended to limit the specific design of the conversion module 320.

In some embodiments, the training device 120 may construct the input information of the decoding module 330 based on the target speech input feature and a preset prompt item. In some embodiments, in one aspect, the preset prompt item may be used to indicate the decoding module 330 to generate a speech recognition result corresponding to the target speech input feature. In another aspect, the preset prompt item may also be used to indicate the decoding module 330 to determine a language type corresponding to the target speech input feature.

As an example, in one aspect, the training device 110 may indicate, based on the preset prompt item, the decoding module 330 to convert the target speech input feature into a corresponding speech recognition result (for example, the rain has stopped now). In another aspect, the preset prompt item may also be used to indicate a language type (for example, Chinese) corresponding to the current target speech input feature of the decoding module 330, so that the decoding module 330 obtains the second text data based on the language type of the prompt better.

In some embodiments, the input information of the decoding module 330 further includes context information of the second set of speech data. For example, text content generated based on historical speech content associated with the second set of speech data; scenario information describing a dialog scenario associated with the second set of speech data; object information describing at least one object associated with the second set of speech data. In this manner, the decoding module 330 may cause the speech recognition model 300 to output more accurate second text data based on the context information.

At block 250, the training device 120 trains the speech recognition model 300 based at least on a comparison between the first text data and the second text data to adjust at least a parameter of the encoding module 310 and the conversion module 320, and the conversion module 320 is configured to convert the speech encoding representation into a speech input feature matching the decoding module 330.

In some embodiments, the speech recognition model 300 may further output a first language type corresponding to the second set of speech data based on the decoding module 330. In addition, the second set of speech data may also annotate a corresponding second language type based on an operation of a user, that is, each type of speech is annotated with a corresponding language type.

As an example, the speech recognition model 300 may output target text content corresponding to the target speech data based on the decoding module 330, and it may further output a target language type (for example, a first language type) of the corresponding target speech data, and the training device 120 adjusts the parameter of the conversion module 320 based on a difference between the first language type and the annotated second language type (for example, as a second loss value) to train the speech recognition model 300.

In some embodiments, the training device 120 may train the speech recognition model 300 based on the first loss value and the second loss value. As an example, in the process of training the speech recognition model 300, the training device 120 may fix a parameter of the decoding module 330; or, the training device 120 may fine-tune a parameter of the decoding module 330; or, the training device 120 may further adjust a parameter of a fine-tuning module (for example, a low-rank adaptation (Lora) module) associated with the decoding module 330.

In some embodiments, the training device 120 may enhance alignment of speech and a text modal based on reinforcement learning, i.e., a small amount of high-quality data and a loss function of reinforcement learning may be used to further train the speech recognition model 300, and performance is further enhanced.

In this way, the embodiments of the present disclosure can support the user to train the speech recognition model based on a plurality of language types, and adjust a parameter of the encoding module and the conversion module in the speech recognition model, thereby improving accuracy and efficiency of speech recognition conversion of a plurality of language types.

### Example Apparatus and Apparatus

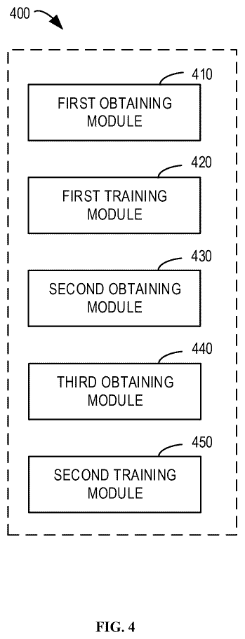

Embodiments of the present disclosure also provide a corresponding apparatus for implementing the above method or process. FIG. 4 shows a schematic structural block diagram of an example apparatus 400 for training a speech recognition model according to some embodiments of the present disclosure. The apparatus 400 may be implemented or included in the electronic device 110 and the training device 120. The various modules/components in the apparatus 400 may be implemented by hardware, software, firmware, or any combination thereof.

As shown in FIG. 4, the apparatus 400 includes a first obtaining module 410 configured to obtain first training data including a first set of speech data corresponding to a plurality of languages; a first training module 420 configured to train a speech recognition model by using the first training data to adjust a parameter of an encoding module of the speech recognition model, the encoding module being configured to convert received speech data into a speech encoding representation; a second obtaining module 430 configured to obtain second training data, the second training data including a second set of speech data corresponding to the plurality of languages and first text data corresponding to the second set of speech data; a third obtaining module 440 configured to process the second set of speech data by using the speech recognition model to obtain second text data; and a second training module 450 configured to train the speech recognition model based at least on a comparison between the first text data and the second text data to adjust at least a parameter of the encoding module and a conversion module of the speech recognition model, the conversion module being configured to convert the speech encoding representation into a speech input feature matching a decoding module of the speech recognition model.

In some embodiments, the third obtaining module 440 is specifically configured to process target speech data in the second set of speech data by using the encoding module to generate a target speech encoding representation corresponding to the target speech data; convert the target speech encoding representation into a target speech input feature by using the conversion module; construct input information based on the target speech input feature and a preset prompt item; and provide the input information to the decoding module to obtain the second text data.

In some embodiments, the prompt item indicates the decoding module to generate a speech recognition result corresponding to the target speech input feature.

In some embodiments, the prompt item further indicates the decoding module to determine a language type corresponding to the target speech input feature.

In some embodiments, the speech recognition model is further trained based on a comparison between a first language type output by the decoding module and an annotated second language type.

In some embodiments, the second training module 450 is specifically configured to adjust a parameter of the conversion module based at least on the comparison between the first text data and the second text data.

In some embodiments, the input information further includes context information indicating at least one of: text content generated based on historical speech content associated with the second set of speech data; scenario information describing a dialog scenario associated with the second set of speech data; or object information describing at least one object associated with the second set of speech data.

In some embodiments, the second training module 450 is specifically configured to fix a parameter of the decoding module; fine-tune a parameter of the decoding module; or adjust a parameter of a fine-tuning module associated with the decode module.

The modules included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

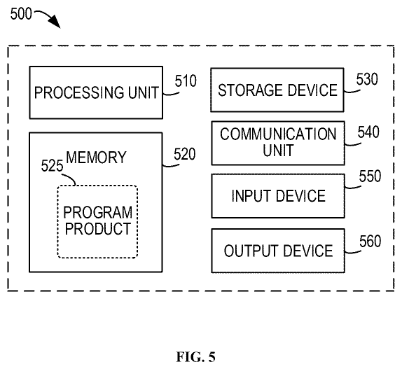

FIG. 5 illustrates a block diagram of an electronic device 500 in which one or more embodiments of the present disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the electronic device 110 and the training device 120 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, a plurality of processing units executes computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in one or more blocks in the flowchart(s) and/or block diagram(s).

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method comprising:
obtaining first training data comprising a first set of speech data corresponding to a plurality of languages;
training a speech recognition model by using the first training data to adjust a parameter of an encoding module of the speech recognition model, the encoding module being configured to convert received speech data into a speech encoding representation;
obtaining second training data, the second training data comprising a second set of speech data corresponding to the plurality of languages and first text data corresponding to the second set of speech data;
processing the second set of speech data by using the speech recognition model to obtain second text data; and
training the speech recognition model based at least on a comparison between the first text data and the second text data to adjust at least a parameter of the encoding module and a conversion module of the speech recognition model, the conversion module being configured to convert the speech encoding representation into a speech input feature matching a decoding module of the speech recognition model.

2. The method of claim 1, wherein processing the second set of speech data by using the speech recognition model to obtain the second text data comprises:
processing target speech data in the second set of speech data by using the encoding module to generate a target speech encoding representation corresponding to the target speech data;
converting the target speech encoding representation into a target speech input feature by using the conversion module;
constructing input information based on the target speech input feature and a prompt item; and
providing the input information to the decoding module to obtain the second text data.

3. The method of claim 2, wherein the prompt item indicates the decoding module to generate a speech recognition result corresponding to the target speech input feature.

4. The method of claim 3, wherein the prompt item further indicates the decoding module to determine a language type corresponding to the target speech input feature.

5. The method of claim 4, wherein the speech recognition model is further trained based on a comparison between a first language type output by the decoding module and an annotated second language type.

6. The method of claim 5, wherein training the speech recognition model based at least on the comparison between the first text data and the second text data comprises:
adjusting a parameter of the conversion module based at least on the comparison between the first text data and the second text data.

7. The method of claim 2, wherein the input information further comprises context information indicating at least one of:
text content generated based on historical speech content associated with the second set of speech data;
scenario information describing a dialog scenario associated with the second set of speech data; or
object information describing at least one object associated with the second set of speech data.

8. The method of claim 1, wherein training the speech recognition model based at least on the comparison between the first text data and the second text data comprises:
fixing a parameter of the decoding module;
fine-tuning a parameter of the decoding module; or
adjusting a parameter of a fine-tuning module associated with the decode module.

9. An electronic device comprising:
at least one processor; and
at least one memory coupled to the at least one processor and storing instructions for execution by the at least one processor, the instructions, when executed by the at least one processor, causing the electronic device to perform operations comprising:
obtaining first training data comprising a first set of speech data corresponding to a plurality of languages;
training a speech recognition model by using the first training data to adjust a parameter of an encoding module of the speech recognition model, the encoding module being configured to convert received speech data into a speech encoding representation;
obtaining second training data, the second training data comprising a second set of speech data corresponding to the plurality of languages and first text data corresponding to the second set of speech data;
processing the second set of speech data by using the speech recognition model to obtain second text data; and
training the speech recognition model based at least on a comparison between the first text data and the second text data to adjust at least a parameter of the encoding module and a conversion module of the speech recognition model, the conversion module being configured to convert the speech encoding representation into a speech input feature matching a decoding module of the speech recognition model.

10. The electronic device of claim 9, wherein processing the second set of speech data by using the speech recognition model to obtain the second text data comprises:
processing target speech data in the second set of speech data by using the encoding module to generate a target speech encoding representation corresponding to the target speech data;
converting the target speech encoding representation into a target speech input feature by using the conversion module;
constructing input information based on the target speech input feature and a prompt item; and
providing the input information to the decoding module to obtain the second text data.

11. The electronic device of claim 10, wherein the prompt item indicates the decoding module to generate a speech recognition result corresponding to the target speech input feature.

12. The electronic device of claim 11, wherein the prompt item further indicates the decoding module to determine a language type corresponding to the target speech input feature.

13. The electronic device of claim 12, wherein the speech recognition model is further trained based on a comparison between a first language type output by the decoding module and an annotated second language type.

14. The electronic device of claim 13, wherein training the speech recognition model based at least on the comparison between the first text data and the second text data comprises:
adjusting a parameter of the conversion module based at least on the comparison between the first text data and the second text data.

15. The electronic device of claim 10, wherein the input information further comprises context information indicating at least one of:
text content generated based on historical speech content associated with the second set of speech data;
scenario information describing a dialog scenario associated with the second set of speech data; or
object information describing at least one object associated with the second set of speech data.

16. The electronic device of claim 9, wherein training the speech recognition model based at least on the comparison between the first text data and the second text data comprises:
fixing a parameter of the decoding module;
fine-tuning a parameter of the decoding module; or
adjusting a parameter of a fine-tuning module associated with the decode module.

17. A non-transitory computer-readable storage medium having a computer program stored thereon, the computer program being executable by at least one processor to implement operations comprising:
obtaining first training data comprising a first set of speech data corresponding to a plurality of languages;
training a speech recognition model by using the first training data to adjust a parameter of an encoding module of the speech recognition model, the encoding module being configured to convert received speech data into a speech encoding representation;
obtaining second training data, the second training data comprising a second set of speech data corresponding to the plurality of languages and first text data corresponding to the second set of speech data;
processing the second set of speech data by using the speech recognition model to obtain second text data; and
training the speech recognition model based at least on a comparison between the first text data and the second text data to adjust at least a parameter of the encoding module and a conversion module of the speech recognition model, the conversion module being configured to convert the speech encoding representation into a speech input feature matching a decoding module of the speech recognition model.

18. The non-transitory computer-readable storage medium of claim 17, wherein processing the second set of speech data by using the speech recognition model to obtain the second text data comprises:
processing target speech data in the second set of speech data by using the encoding module to generate a target speech encoding representation corresponding to the target speech data;
converting the target speech encoding representation into a target speech input feature by using the conversion module;
constructing input information based on the target speech input feature and a prompt item; and
providing the input information to the decoding module to obtain the second text data.

19. The non-transitory computer-readable storage medium of claim 18, wherein the prompt item indicates the decoding module to generate a speech recognition result corresponding to the target speech input feature.

20. The non-transitory computer-readable storage medium of claim 19, wherein the prompt item further indicates the decoding module to determine a language type corresponding to the target speech input feature.
